(19) United States
(12) Patent Application Publication
(10) Pub. No.: US 2014/0162052 A1
(43) Pub. Date: Jun. 12, 2014

(54) SILICON DIOXIDE SOL, SURFACE TREATMENT METHOD FOR METAL SUBSTRATE USING THE SILICON DIOXIDE SOL AND ARTICLE MANUFACTURED BY THE SAME

(71) Applicants: SHENZHEN FUTAIHONG PRECISION INDUSTRY CO., LTD., Shenzhen (CN); FIH (HONG KONG) LIMITED, Kowloon (HK)

(72) Inventor: TING DING, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/721,654

(22) Filed: Dec. 20, 2012

(30) Foreign Application Priority Data
Dec. 7, 2012 (CN) 201210521531.6

(51) Int. Cl. C09D 7/12

(52) U.S. Cl. CPC C09D 7/1216
USPC 428/328; 106/287.14; 427/397.7; 427/123; 427/125; 428/450; 428/331; 428/335

(57) ABSTRACT

A silicon dioxide sol comprises tetraethyl silicate, dimethylformamide, 1,2-bis(triethoxysilyl)ethane, absolute ethanol, hydrochloric acid, and water. A surface treatment method for metal substrate using the silicon dioxide sol and a coated article manufactured by the method is also provided, the resulting coating providing significantly better anti-corrosion and anti-wear properties.

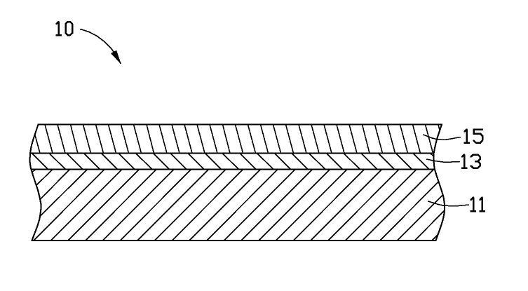

### BACKGROUND

1. Technical Field

The present disclosure relates to a silicon dioxide sol, a surface treatment method for metal substrate using the silicon dioxide sol and articles manufactured by the surface treatment method.

2. Description of Related Art

To enhance corrosion resistance, aluminum alloy substrates are treated by chromate before forming electrophoretic layers on the aluminum alloy substrates. However, the chromate containing Cr⁶⁺ ion is a toxic material and causes environmental pollution. Nowadays, a rare earth solution is used instead of chromate to form rare earth oxide layers on the aluminum alloy substrates. But, the period of time for forming the rare earth oxide layers is lengthy. Furthermore, the ingredients of the rare earth solution are complicated to use. Thus, rare earth solutions are not widely used in industry.

Therefore, there is room for improvement within the art.

### BRIEF DESCRIPTION OF THE DRAWINGS

Many aspects of the embodiment can be better understood with reference to the drawing. The components in the drawing are not necessarily drawn to scale, the emphasis instead being placed upon clearly illustrating the principles of the exemplary disclosure.

The figure is a schematic view of an exemplary embodiment of an article coated with silicon dioxide.

### DETAILED DESCRIPTION

According to an exemplary embodiment, a silicon dioxide sol substantially includes tetraethyl silicate (TEOS), dimethylformamide (DMF), 1,2-bis(triethoxysilyl)ethane (BTESE), conductive metal powder, absolute ethanol, hydrochloric acid and water, wherein the volume percentage of TEOS is about 30% to about 40%, the volume percentage of DMF is about 2% to about 4%, the volume percentage of BTESE is about 20% to about 30% , the volume percentage of conductive metal powder is about 5% to about 10%, the volume percentage of absolute ethanol is about 10% to about 15%, the volume percentage of hydrochloric acid is about 3% to about 5%, and the volume percentage of water is about 20% to about 25%. The pH value of the silicon dioxide sol is about 2 to about 4.

DMF acts as complexing agent to form a chelation with intermediate product which is hydrolyzed by TEOS, and also can reduce the polycondensation rate of the silicon dioxide sol to prevent any cracking in a layer formed by silicon dioxide sol.

BTESE is for enhancing the density of the layer formed by the silicon dioxide sol and providing a secure bond between the layer and the metal substrate.

Hydrochloric acid acts as catalyst for providing H₃O⁺ ions to promote film formation. Hydrochloric acid can also adjust the pH value of the silicon dioxide sol.

The conductive metal powder may be aluminium powder, antimony powder or silver powder. The particles of conductive metal powder having a nano-scale size provide improved dispersibility of the conductive metal powder and conductivity of the silicon dioxide sol. In the embodiment, the conductive metal powder has a particle size in a range of about 30 nm to about 50 nm.

The silicon dioxide sol is formed as follows:

TEOS, DMF, water and BTESE are mixed in absolute ethanol, and then conductive metal powder is added to the mixture. The pH value of mixture is adjusted to a range from 2 to 4 by adding hydrochloric acid. The mixture is stirred and filtered to separate out a silicon dioxide sol.

In the silicon dioxide sol, the volume percentage of TEOS is about 30% to about 40%, the volume percentage of DMF is about 2% to about 4%, the volume percentage of BTESE is about 20% to about 30% , the volume percentage of conductive metal powder is about 5% to about 10%, the volume percentage of absolute ethanol is about 10% to about 15%, the volume percentage of hydrochloric acid is about 3% to about 5%, and the volume percentage of water is about 20% to about 25%.

A surface treatment method for metal substrate using the silicon dioxide sol may at least include the following steps:

A metal substrate 11 is provided. The metal substrate 11 may be made of aluminum, aluminum alloy, magnesium, or magnesium alloy.

A silicon dioxide gel layer 13 is formed on the metal substrate 11 as follows:

A silicon dioxide sol layer is formed on the metal substrate by coating or immersing; and then the silicon dioxide sol is converted to silicon dioxide gel by vacuum drying the metal substrate 11 at a temperature of about 40° C. to about 50° C. for about 10 min to about 15 min.

The silicon dioxide gel is heated to form a silicon dioxide gel layer 13 on the metal substrate 11. A furnace (not shown) is provided, and the furnace is heated to about 100° C. to about 120° C. The metal substrate 11 is positioned in the furnace, and the internal temperature of the furnace is maintained at about 100° C. to about 120° C. for about 10 min to about 15 min. The internal temperature of the furnace is increased to a range from 400° C. to 500° C. and maintained at the temperature for about 30 min to about 50 min.

The silicon dioxide gel layer 13 has a thickness of about 10 nm to 100 nm. In the embodiment, the silicon dioxide gel layer 13 has a thickness of about 20 nm to 30 nm.

During the heat treatment, the BTESE bonds to the metal substrate 11 to form Si—O—M bonds, wherein M is aluminum (Al) or magnesium (Mg). The Si—O—M bonds provide an improved bond between the silicon dioxide gel layer 13 and the metal substrate 11. Some of TEOS aggregate into a (O—Si—O)n network structure. The (O—Si—O)n network structure is filled with nano silicon dioxide particles formed by the remnant of TEOS. Some of the BTESE connects therebetween or/and intersects with TEOS, which acts to provide an improved compactness and corrosion resistance. The nano silicon dioxide particles have a particle size in a range of about 10 nm to about 20 nm.

BTESE has a lower corrosion potential and higher resistance polarization compared to aluminum alloy or magnesium alloy, which enhances the corrosion resistance of the silicon dioxide gel layer 13.

An electrophoretic layer 15 is formed on the metal substrate 11. During the electrophoresis process, the electrophoresis voltage is about 95V to about 100V, the metal substrate 11 is positioned in a electrophoretic paint for about 2 min to about 3 min, the temperature of the electrophoretic paint is room temperature. Then, the metal substrate 11 coated with an electrophoretic layer 13 is taken out of the electrophoretic paint. The metal substrate 11 is washed by water to remove remains of the electrophoretic paint, and followed by a solidifying treatment.

In the embodiment, the electrophoretic paint contains acrylic resin, methyl acrylate, isopropyl alcohol, diaceton alcohol, butyl alcohol, 2-aminoethanol and organic pigment, wherein the mass percentage of the acrylic resin is about 15% to about 20%, the mass percentage of the methyl acrylate is about 15% to about 20%, the mass percentage of the isopropyl alcohol is about 4% to about 6%, the mass percentage of the diaceton alcohol is about 3% to about 5%, the mass percentage of the butyl alcohol is about 3% to about 5%, the mass percentage of the 2-aminoethanol is about 7% to about 10%, the volume percentage of hydrochloric acid is about 3% to about 5%, and the volume percentage of water is about 20% to about 25%. In the embodiment, the organic pigment is quinacridone. The organic pigment has a particle size in a range of about 10 μm to about 25 μm. The electrophoretic layer 15 has a thickness of about 20 μm to about 50 μm.

The figure shows an article 10 which includes a metal substrate 11, a silicon dioxide gel layer 13 formed on the metal substrate 11 and a electrophoretic layer 15 formed on the silicon dioxide gel layer 13.

The silicon dioxide gel layer 13 includes a (O—Si—O)n network structure formed by some of TEOS, BTESE, nano silicon dioxide particles formed by the remnant of TEOS, and conductive metal powder. BTESE is bonded to the metal substrate 11 to form Si—O—M bonds, wherein M is aluminum (Al) or magnesium (Mg). Some of the TEOS aggregates into a (O—Si—O)n network structure. The nano silicon dioxide particles is filled in the (O—Si—O)n network structure. Some of the BTESE connects or/and intersects with TEOS, which acts to provide an improved compactness and corrosion resistance.

The nano silicon dioxide particles have a particle size in a range of about 10 nm to about 20 nm.

The conductive metal powder may be aluminium powder, antimony powder or silver powder. The conductive metal powder having nano-size particles provides improved dispersibility of the conductive metal powder and conductivity of the silicon dioxide sol. In the embodiment, the conductive metal powder has a particle size in a range of about 30 nm to about 50 nm.

The electrophoretic layer 15 has a thickness of about 20 μm to about 50 μm.

The silicon dioxide gel layer 13 formed between the metal substrate 11 and the electrophoretic layer 15 prevents oxygen and electrolyte solution reaching or diffusing to the metal substrate 11, thus improving the corrosion resistance of the article 10. Additionally, the conductive metal powder provides a secure bond between the metal substrate 11 and the electrophoretic layer 15, which acts to further enhance the corrosion resistance of the article 10.

### EXAMPLE 1

A metal substrate 11 was provided. The metal substrate 11 was made of aluminum alloy.

A silicon dioxide sol was provided. In the silicon dioxide sol, the volume percentage of TEOS was about 38%, the volume percentage of DMF was about 2%, the volume percentage of BTESE was about 20%, the volume percentage of conductive metal powder was about 5%, the volume percentage of absolute ethanol was about 10%, volume percentage of hydrochloric acid is about 3%, and the volume percentage of water is about 22%. The pH value of the silicon dioxide sol was about 3.5.

A silicon dioxide gel layer 13 was formed on the metal substrate 11 as follows:

A silicon dioxide sol layer was formed on the metal substrate by coating, and then silicon dioxide sol was converted to silicon dioxide gel by vacuum drying the metal substrate 11 at a temperature of about 40° C. for about 12 min.

The silicon dioxide gel was heated to form a silicon dioxide gel layer 13 on the metal substrate 11. The metal substrate 11 was positioned in the furnace for about 15 mins, the internal temperature of the furnace was about 100° C. Then, the internal temperature of the furnace was increased to about 500° C. and maintained at that temperature for about 30 min.

The silicon dioxide gel layer 13 has a thickness of about 20 nm.

An electrophoretic layer 15 was formed on the silicon dioxide gel layer 13. During the electrophoresis process, the electrophoresis voltage was about 100V, the metal substrate 11 was positioned in a electrophoretic paint for about 3 min, the temperature of the electrophoretic paint was room temperature. The electrophoretic paint contained acrylic resin, methyl acrylate, isopropyl alcohol, diaceton alcohol, butyl alcohol, 2-aminoethanol and quinacridone.

### EXAMPLE 2

Unlike example 1, the silicon dioxide sol for forming the silicon dioxide gel layer 13 is heat treated as follows: the metal substrate 11 was positioned in the furnace for about 10 min, the internal temperature of the furnace is about 120° C. Then, the internal temperature of the furnace was increased to about 400° C. and maintained at the temperature for about 50 mins. Except for the above difference, the remaining conditions for example 2 were the same as in example 1.

### COMPARISON EXAMPLE

Unlike example 1, a comparison example lacked the silicon dioxide gel layer 13 between the metal substrate 11 and the electrophoretic layer 15. Except for the above difference, the remaining conditions for the comparison example were the same as in example 1.

### Results of Example 1-2 and the Comparison Example

Salt spray test and wear resistance test were performed on the coatings of example 1-2 and the comparison example.

A salt spray test was performed on the articles formed by the example 1-2 and the comparison example. The salt spray test used a sodium chloride (NaCl) solution having a mass concentration of 5% at a temperature of 35° C. The test indicated that the integrity of the coating of example 1 and 2 lasted more than 168 hours (h) respectively, and that of the article of the comparison example lasted 124 h. Thus, the article of example 1 had a good corrosion resistance property.

Wear resistance testing was carried out as follows. The samples manufactured by the example 1-2 and the comparison example were tested using an “R180/530TE30” -type trough vibrator made by Rosier Company. “RKS10K” type yellow cone abrasive, “RKK15P” type green pyramid abrasive, and “FC120” type detergent were held in the trough vibrator. The volume ratio of the “RKS 10K” type yellow cone abrasive and the “RKK15P” type green pyramid abrasive was 3:1. The “RKS 10K” type yellow cone abrasive and the “RKK15P” type green pyramid abrasive were made by Rosier Company.

The tests showed no peeling occurring on coatings of example 1 and 2, and showed only a few small scratches on the electrophoretic layer 15 of example 1 and 2. Some peeling of the electrophoretic layer was found in the coatings in the comparison example. That is, the article 10 of example 1 and 2 had better wear resistance than that of the article of comparison example.

It is to be understood, however, that even through numerous characteristics and advantages of the exemplary disclosure have been set forth in the foregoing description, together with details of the system and functions of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A silicon dioxide sol, comprising:
tetraethyl silicate;
dimethylformamide;
1,2-bis(triethoxysilyl)ethane;
absolute ethanol;
hydrochloric acid; and
water.

2. The silicon dioxide sol as claimed in claim 1, wherein in the silicon dioxide sol, the volume percentage of TEOS is about 30% to about 40%, the volume percentage of DMF is about 2% to about 4%, the volume percentage of BTESE is about 20% to about 30% , the volume percentage of absolute ethanol is about 10% to about 15%, the volume percentage of hydrochloric acid is about 3% to about 5%, and the volume percentage of water is about 20% to about 25%.

3. The silicon dioxide sol as claimed in claim 1, wherein the pH value of the silicon dioxide sol is about 2 to about 4.

4. The silicon dioxide sol as claimed in claim 1, further comprising conductive metal powder.

5. The silicon dioxide sol as claimed in claim 4, wherein the conductive metal powder is aluminium powder, antimony powder or silver powder.

6. The silicon dioxide sol as claimed in claim 5, wherein the conductive metal powder has a particle size in a range of about 30 nm to about 50 nm.

7. A surface treatment method for metal substrate using the silicon dioxide sol, comprising:
providing a metal substrate;
providing a silicon dioxide sol, the silicon dioxide sol comprises tetraethyl silicate, dimethylformamide, 1,2-bis(triethoxysilyl)ethane, absolute ethanol, hydrochloric acid, and water;
forming a silicon dioxide sol layer on the metal substrate;
heating the silicon dioxide sol layer at a internal temperature of a furnace of about 400° C. to 500° C. to form a silicon dioxide gel layer on the metal substrate, the silicon dioxide gel layer comprising a (O—Si—O)n network structure formed by some of tetraethyl silicate, 1,2-bis(triethoxysilyl)ethane, nano silicon dioxide particles formed by the remnant of tetraethyl silicate, and conductive metal powder, 1,2-bis(triethoxysilyl)ethane substantially bonding to the metal substrate to form Si—O—M bonds, wherein M is aluminum (Al) or magnesium (Mg); the nano silicon dioxide particles being filled in the (O—Si—O)n network structure, some of the 1,2-bis(triethoxysilyl)ethane connecting therebetween or/and intersecting with tetraethyl silicate.

8. The surface treatment method as claimed in claim 7, wherein in the silicon dioxide sol, the volume percentage of TEOS is about 30% to about 40%, the volume percentage of DMF is about 2% to about 4%, the volume percentage of BTESE is about 20% to about 30%, the volume percentage of absolute ethanol is about 10% to about 15%, the volume percentage of hydrochloric acid is about 3% to about 5%, and the volume percentage of water is about 20% to about 25%.

9. The surface treatment method as claimed in claim 8, wherein the pH value of the silicon dioxide sol is about 2 to about 4.

10. The surface treatment method as claimed in claim 7, wherein the silicon dioxide sol further comprises conductive metal powder.

11. The surface treatment method as claimed in claim 10, wherein the conductive metal powder is aluminium powder, antimony powder or silver powder.

12. The surface treatment method as claimed in claim 11, wherein the conductive metal powder has a particle size in a range of about 30 nm to about 50 nm.

13. The surface treatment method as claimed in claim 7, further comprising a step of forming an electrophoretic layer on the silicon dioxide gel layer.

14. A article, comprising:
a metal substrate; and
a silicon dioxide gel layer formed on the metal substrate, the silicon dioxide gel layer comprising a (O—Si—O)n network structure formed by some of tetraethyl silicate, 1,2-bis(triethoxysilyl)ethane, nano silicon dioxide particles formed by the remnant of tetraethyl silicate, and conductive metal powder, 1,2-bis(triethoxysilyl)ethane substantially bonding to the metal substrate to form Si—O—M bonds, wherein M is aluminum (Al) or magnesium (Mg); the nano silicon dioxide particles being filled in the (O—Si—O)n network structure, some of the 1,2-bis(triethoxysilyl)ethane connecting therebetween or/and intersecting with tetraethyl silicate.

15. The article as claimed in claim 14, wherein the nano silicon dioxide particles have a particle size in a range of about 10 nm to about 20 nm.

16. The article as claimed in claim 14, wherein the silicon dioxide gel layer further comprises conductive metal powder.

17. The article as claimed in claim 16, wherein the conductive metal powder is aluminium powder, antimony powder or silver powder.

18. The article as claimed in claim 17, wherein the conductive metal powder has a particle size in a range of about 30 nm to about 50 nm.

19. The article as claimed in claim 14, further comprising an electrophoretic layer formed on the silicon dioxide gel layer.

20. The article as claimed in claim 19, wherein the electrophoretic layer has a thickness of about 20 μm to about 50 μm.
